(19) United States
(12) Patent Application Publication
(10) Pub. No.: US 2021/0169729 A1
(43) Pub. Date: Jun. 10, 2021

(54) FASCIA TISSUE FITNESS DEVICES

(71) Applicant: Ashley Diana Black International Holdings, LLC, Pearland, TX (US)

(72) Inventor: Ashley D. Black, Pearland, TX (US)

(73) Assignee: Ashley Diana Black International Holdings, LLC, Pearland, TX (US)

(21) Appl. No.: 17/179,329

(22) Filed: Feb. 18, 2021

Related U.S. Application Data
(63) Continuation of application No. 15/588,407, filed on May 5, 2017.
(60) Provisional application No. 62/332,403, filed on May 5, 2016.

(51) Int. Cl. A61H 7/00; A61H 39/04; A61H 23/02; B05B 11/00

(52) U.S. Cl. CPC A61H 7/003; A61H 2201/0153; A61H 39/04; A61H 23/02; B05B 11/30; A61H 2201/1692; A61H 2201/105; A61H 2207/00; A61H 2201/0188; A61H 2201/1685; A61H 2201/5005; A61H 2201/5043; A61H 2205/106; A61H 2201/0207; A61H 2205/022; A61H 2205/06; A61H 2201/123; A61H 2205/04; A61H 2201/1669; A61H 2201/5061; A61H 2201/1238; A61H 2205/12; A61H 2205/062; A61H 2205/10; A61H 2201/5082; A61H 2205/065; A61H 2201/0107; A61H 2201/0228; A61H 2201/5058; A61H 2201/0161; A61H 7/005

(57) ABSTRACT

A fascia tissue fitness device may include a structural member, at least one fascia tissue treatment element configured to be moved relative to the structural member, a translation member supported by the structural member onto which the at least one treatment element is affixed, and an actuator coupled to the translation member. The actuator may be configured to cause the translation member to repeatedly move back and forth relative to the structural member such that the at least one fascia tissue treatment element moves back and forth to treat fascia tissue of a user. A pressure sensor may be configured to sense pressure being applied to a user by the at least one fascia tissue treatment element.

### RELATED APPLICATIONS

This application is a continuation of co-pending U.S. application Ser. No. 15/588,407, filed May 5, 2017, which claims priority to U.S. Provisional application having Ser. No. 62/332,403 filed on May 5, 2016; the contents of each are hereby incorporated by reference in their entirety.

### BACKGROUND

Fascia tissue is a layer of fibrous tissue that operates as a connective tissue that surrounds muscles, groups of muscles, nerves, blood vessels, etc. The tissue allows for proper functioning of muscles with respect to one another (e.g., sliding past one another). When fascia tissue becomes damaged through injury, tissue knots, medical reasons, or otherwise, the fascia tissue can take time to correct itself or require manipulation to release the fascia tissue and allow for proper functioning of the tissue to allow the underlying muscle to properly operate. In some cases, the fascia tissue can be released or corrected without much difficulty, while in other cases, restoring the fascia tissue to its proper form can take considerably more effort. Other reasons for releasing fascia tissue may include cosmetic reasons, especially for people who have dimpled skin, which is often caused by fascia tissue extending through fat cells, thus causing dimples to appear on the skin. Often, when the fascia tissue is properly released, the dimples can be considerably reduced or eliminated.

In treating fascia tissue, a lubricant, typically in the form of oil, is generally applied to skin of a person being treated to enable the person or treater to manipulate and release the fascia, especially if a treatment device is being utilized. The lubricant may be stored in a bottle, such as a spray bottle, to enable the user to spray the lubricant on his or her skin prior to treatment. Spray bottles, however, are typically small in size to enable a user to more easily use them. A non-spray bottle, such as a pump dispenser bottle, would allow for lubricant to be stored in bulk, but would require a user to touch the lubricant with his or her hands, which is messy and often undesirable. Accordingly, another technique to store and apply lubricant to a person's skin is needed.

Still yet, the use of a tissue fitness device by a user is quite possible and relatively easy to self-treat fascia tissue. However, because a user may not be mechanically inclined, unskilled or untrained in the use of fascia tissue manipulation, or otherwise, the user may be receive an adequate or optimum tissue fitness. Moreover, depending on the locations at where the fascia is to be treated, the use of a standard fascia tissue fitness device may not be suitable.

### SUMMARY

A device may be configured to provide for fitness of fascia tissue. The device may include a bar along which “flower” members having a number of “finger” or “leg” members are fixedly positioned. In one embodiment, the bar may have handle regions at each end with a certain number, such as four, of flower members linearly positioned thereon. The bar and handle regions may be molded as a single piece of material. The handle regions may be defined by grippers formed of rubber or other material over the handle regions with protrusions to provide for additional gripping for a user. The handle regions may have the same or different circumference as the bar. The handle regions may be positioned about the width of human shoulders. The material of the flower members may be PVC, acrylic, or any other material that provides for rubbing across human skin without cutting or scratching. As a lubricant is generally used during usage of the device, a variety of different materials for the finger members may be utilized.

A fascia tissue fitness device may include a bar and multiple flower members connected to the bar along a plane. The flower members may each include multiple finger members that are stiff and extend outward from the bar.

One method of manufacturing a fascia tissue fitness device may include providing a bar, providing multiple flower members, and connecting the flower members to the bar.

One embodiment of an apparatus may include a first linear bar member inclusive of a first connector mechanism. At least one first flower member may be connected to the first linear bar member, where the first flower member(s) include a plurality of first finger members that are rigid and extend outward from the first bar member. A second linear bar member may include a second connector mechanism. At least one second flower member may be connected to the second linear bar member, where the second flower member(s) include multiple second finger members that are rigid and extend outward from the second bar member. The first linear bar member and the second linear bar member may be connectable such that when the first and second linear bar members are connected by the first and second connector mechanisms, a rigid, linear bar may be formed with the first and second flowers being aligned along a plane.

One embodiment of a fascia tissue fitness device may include a bar member, at least one flower member connected to the bar member along a plane, where the flower member(s) include multiple finger members that are rigid and extend outward from the bar member. Means for dispensing a lubricant from the bar member.

Another embodiment of a fascia tissue fitness device may include a bar member, at least one flower member connected to the bar member along a plane. The flower member(s) may include multiple finger members that are rigid and extend outward from the bar member. The bar member may define a hollow portion in which a lubricant is stored and dispensed via an opening further defined by the bar member.

Another fascia tissue fitness device may include a bar member and at least one flower member connected to the bar member along a plane. The flower member(s) may include multiple finger members that are rigid and extend outward from the bar member. A handle may be disposed on an end of the bar member, where the handle may define (i) a hollow portion configured to store a lubricant, (ii) an opening through which the lubricant is dispensed, and (iii) an activation mechanism that, when depressed, causes the lubricant to be dispensed via the opening.

A fascia tissue fitness device may include a bar member, at least one flower member may be connected to the bar member along a plane. The flower member(s) may include multiple finger members that are rigid and extend outward from the bar member. A heater element may be disposed within the bar member, and be in thermal communication with the flower member(s) to cause the fingers to be heated when the heater element is activated.

Another embodiment of a fascia tissue fitness device may include a bar member, at least one flower member connected to the bar member along a plane. The flower member(s) may include multiple finger members that are rigid and extend outward from the bar member. A vibration generation mechanism may be disposed within the bar member, and be configured to cause the flower member(s) to vibrate.

Another fascia tissue fitness device may include a bar member and at least one flower member connected to the bar member along a plane. The flower member(s) may include multiple finger members that are rigid and extend outward from the bar member. A translation member may be disposed within the bar member onto which the flower member(s) are affixed. An actuator may be coupled to the translation member, and be configured to cause the translation member to repeatedly move axially back and forth within the bar member.

Another fascia tissue fitness device may include a bar member and at least one flower member connected to the bar member along a plane. The flower member(s) may include multiple finger members that are rigid and extend outward from the bar member. The bar member may be configured to removably secure a treatment accessory mechanism.

A fascia tissue fitness device may include a structural member, at least one fascia tissue treatment element configured to be moved relative to the structural member, a translation member supported by the structural member onto which the at least one treatment element is affixed, and an actuator coupled to the translation member. The actuator may be configured to cause the translation member to repeatedly move back and forth relative to the structural member such that the at least one fascia tissue treatment element moves back and forth to treat fascia tissue of a user. A pressure sensor may be configured to sense pressure being applied to a user by the at least one fascia tissue treatment element.

### BRIEF DESCRIPTION

A more complete understanding of the method and apparatus of the present invention may be obtained by reference to the following Detailed Description when taken in conjunction with the accompanying Drawings wherein:

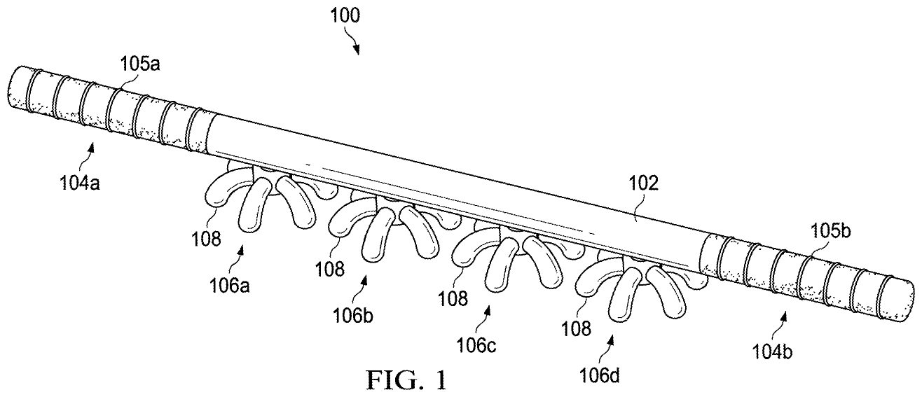

FIG. 1 is an illustration of a rear isometric view of an illustrative fascia tissue fitness device;

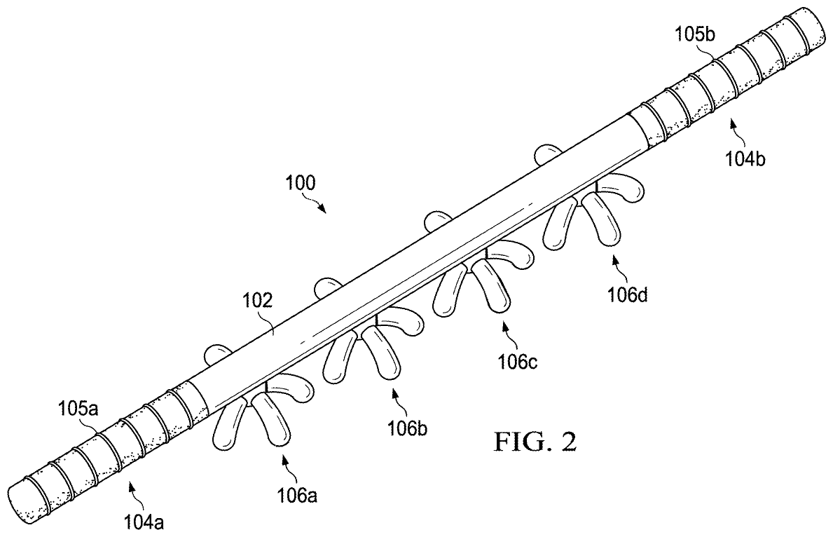

FIG. 2 is another illustration of a rear isometric view of the illustrative fascia tissue fitness device of FIG. 1;

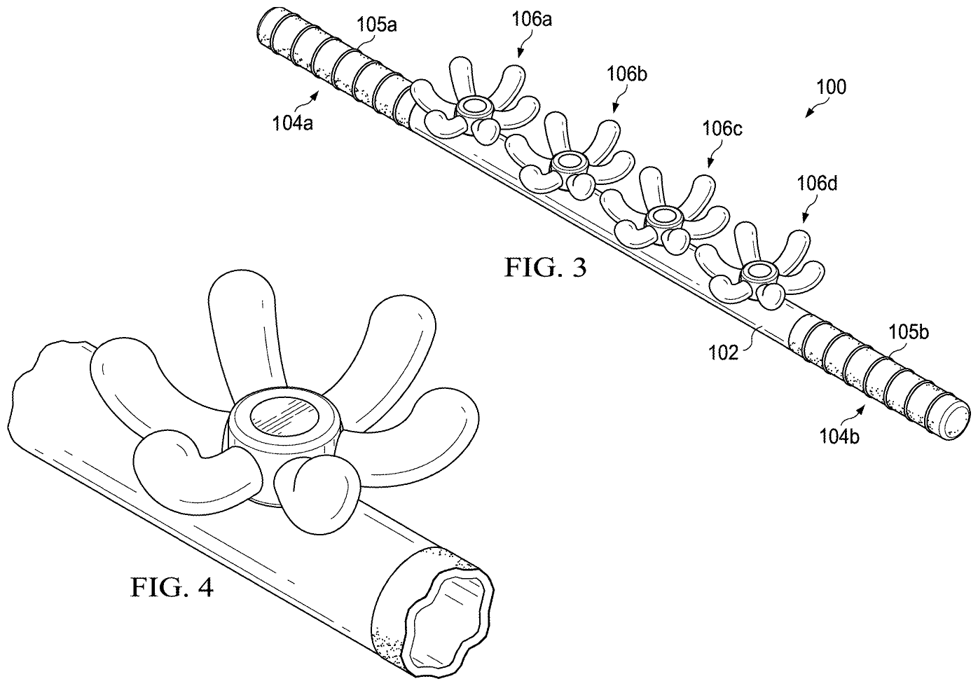

FIG. 3 is an illustration of a front isometric view of the illustrative fascia tissue fitness device of FIG. 1;

FIG. 4 is an illustration of a close-up view of a “flower” member mounted to the bar of the illustrative fascia tissue fitness device of FIG. 1;

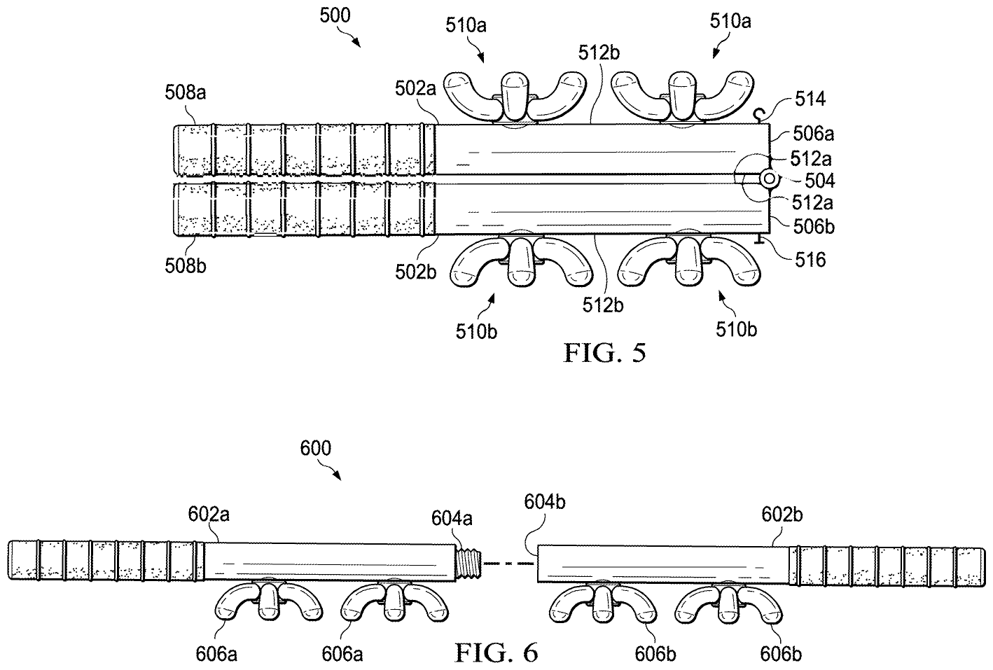

FIG. 5 is an illustration of an illustrative device inclusive of a first linear bar member and a second linear bar member;

FIG. 6 is an illustration of an illustrative fascia tissue fitness device;

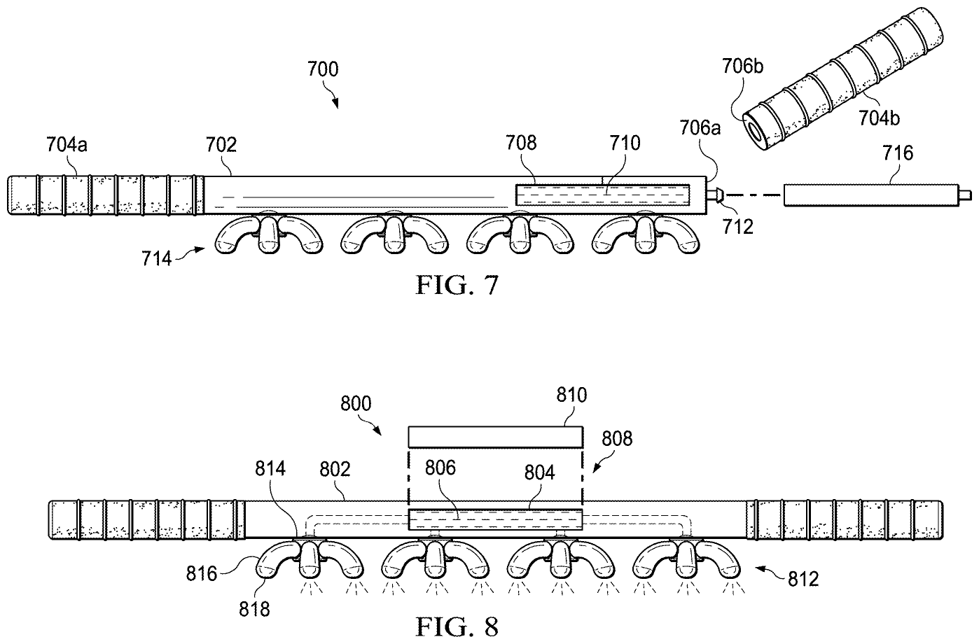

FIG. 7 is an illustration of a fascia tissue fitness device shown to include a bar member inclusive of a first handle and a second handle;

FIG. 8 is an illustration of an alternative embodiment of a fascia tissue fitness device shown to include a bar member that defines an hollow region in which a lubricant may be disposed;

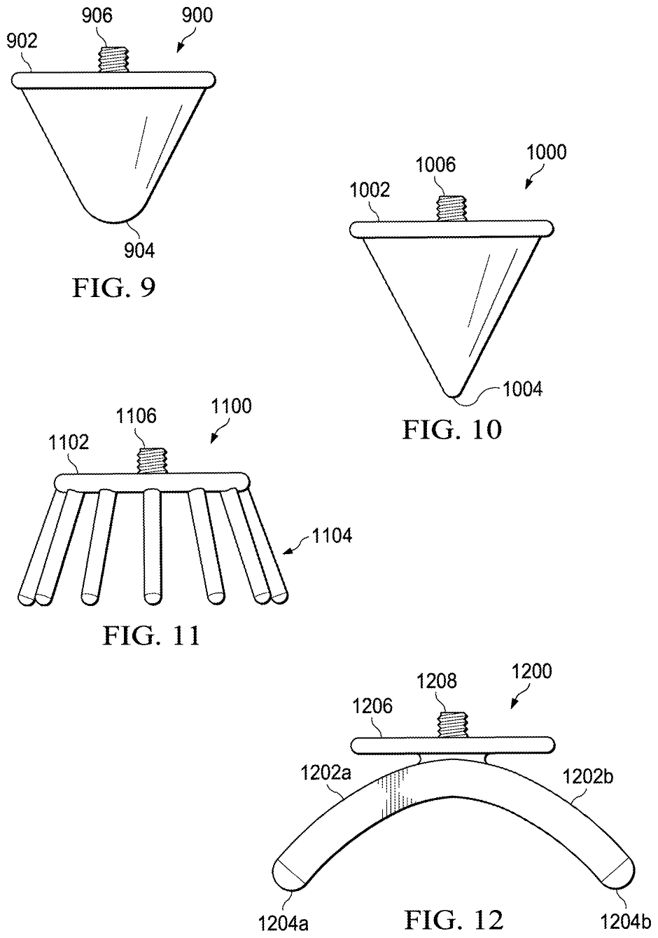

FIG. 9 is an illustration of an illustrative implement configured to massage or otherwise treat fascia tissue in a localized region, such as a hand;

FIG. 10 is an illustration of an alternative illustrative implement configured to massage or otherwise treat fascia tissue in a localized region, such as a hand;

FIG. 11 is an illustration of an illustrative implement that may operate as a skin stimulator;

FIG. 12 is an illustration of an illustrative implement that is configured as a fascia traction device;

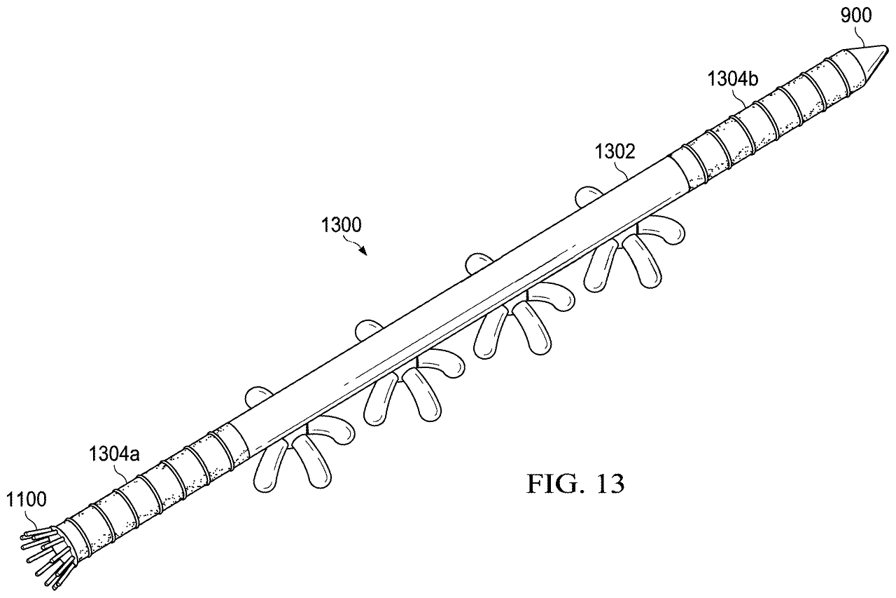

FIG. 13 is an illustrative fascia tissue fitness device inclusive of a bar member and handles;

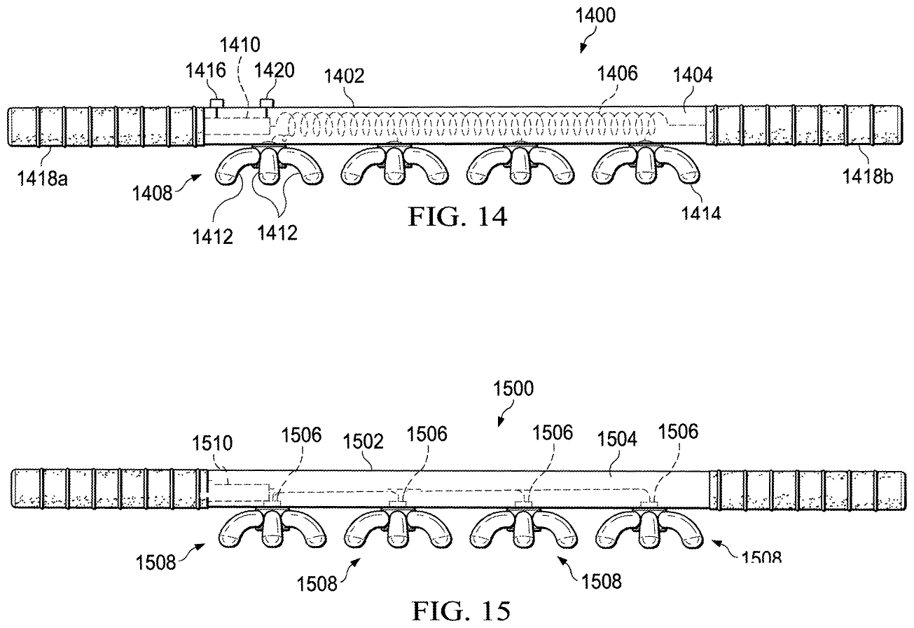

FIG. 14 is an illustration of an illustrative fascia tissue fitness device shown to include a bar member defining a hollow portion in which at least one heating element, such as a heating coil, may be disposed, and configured to heat at least one flower member;

FIG. 15 is an illustration of an illustrative fascia tissue fitness device configured to provide vibration during treatment;

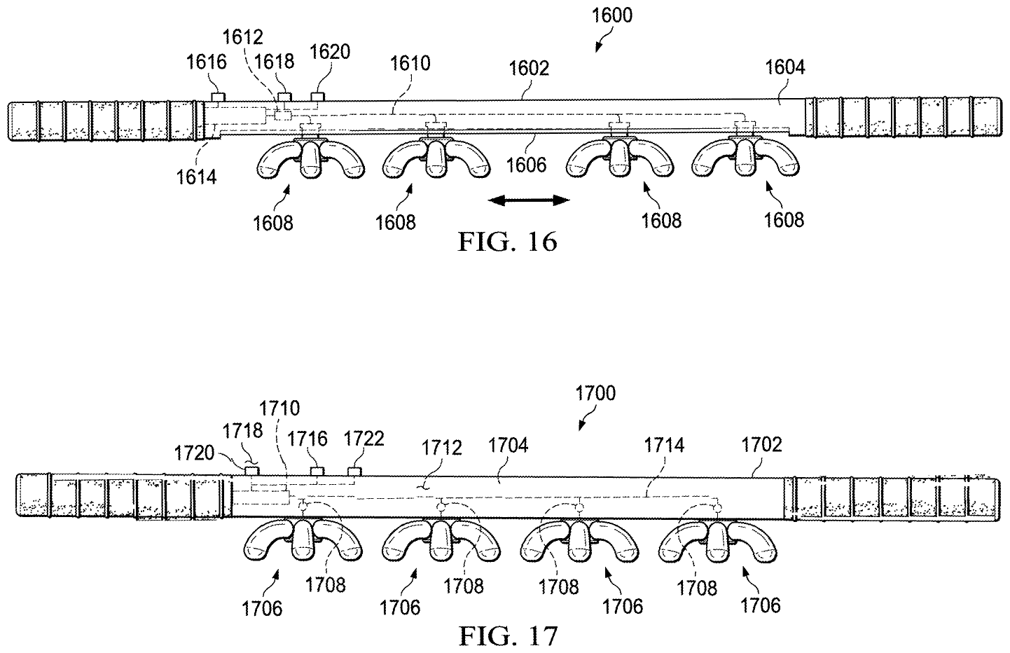

FIG. 16 is an illustration of an illustrative fascia tissue fitness device that includes a bar member that defines a hollow region;

FIG. 17 is an illustration of an illustrative fascia tissue fitness device that includes a bar member that defines a hollow region;

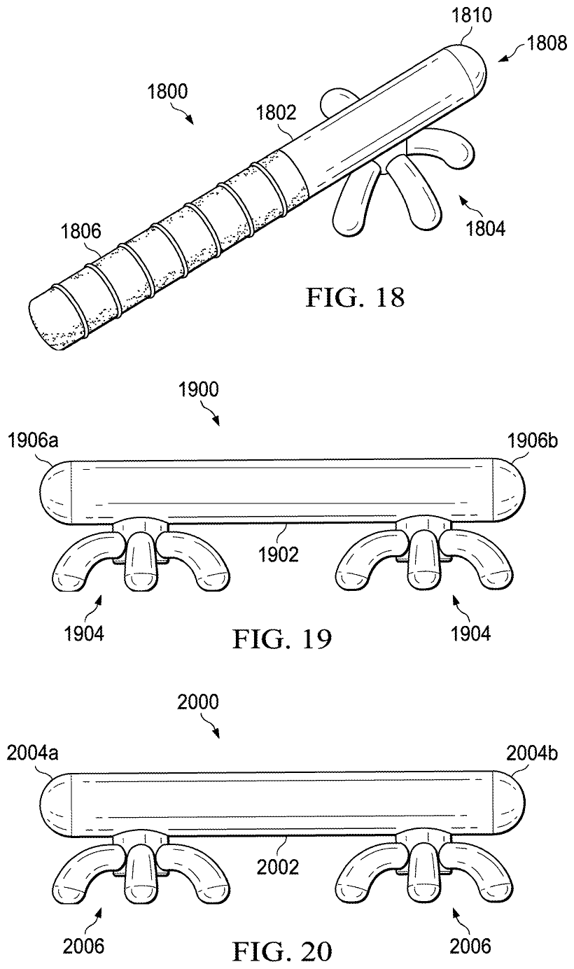

FIG. 18 is an illustration of an illustrative fascia tissue fitness device that includes a bar member and one or more flower members;

FIG. 19 is an illustration of another illustrative fascia tissue fitness device that includes a bar member and one or more flower members;

FIG. 20 is an illustration of an illustrative fascia tissue fitness device that is a scaled model of the fascia tissue treating device of FIG. 19;

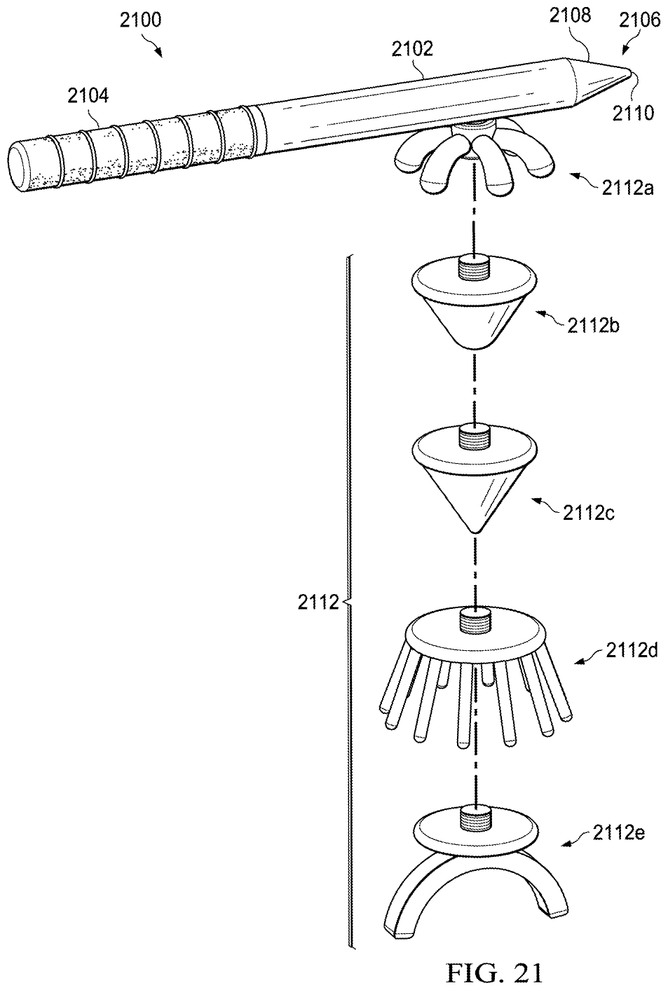

FIG. 21 is an illustration of an illustrative fascia tissue fitness device that is formed of a bar member inclusive of a handle;

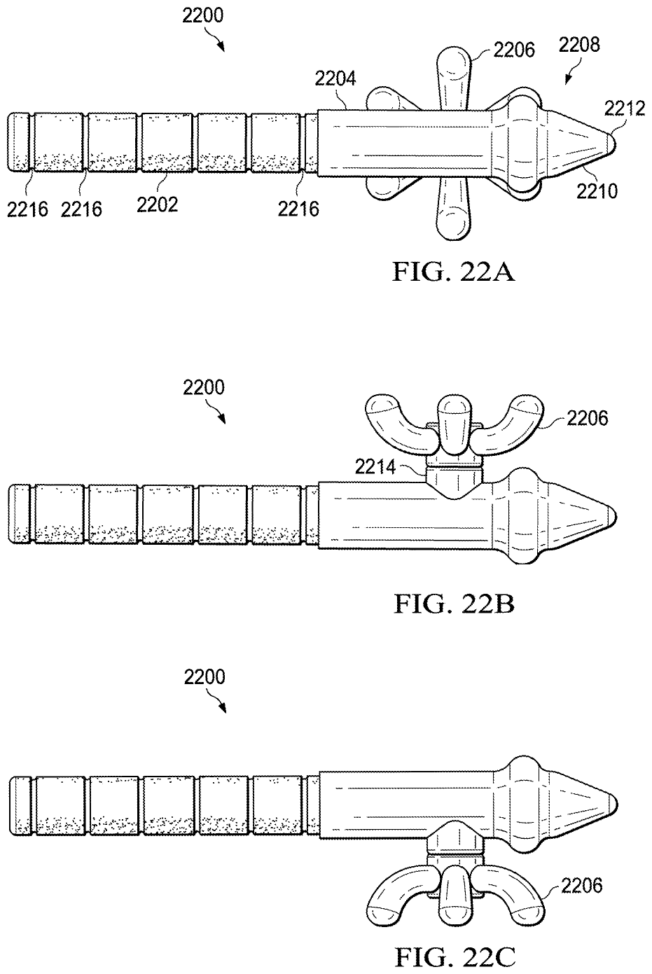

FIGS. 22A, 22B and 22C are three illustrations of an illustrative fascia tissue fitness device;

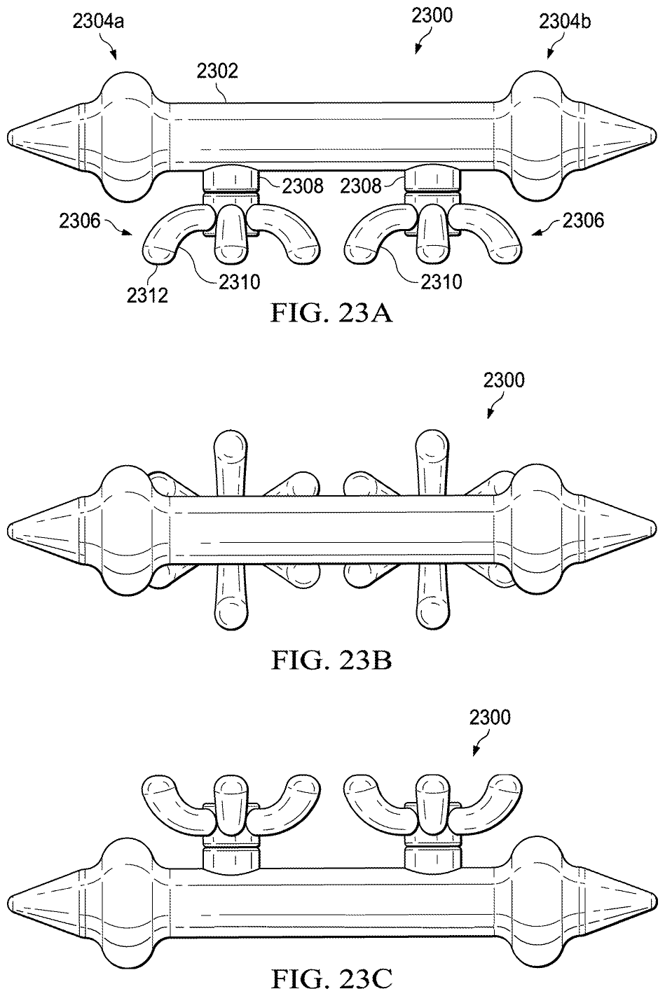

FIGS. 23A, 23B, and 23C are illustrations of an illustrative fascia tissue fitness device;

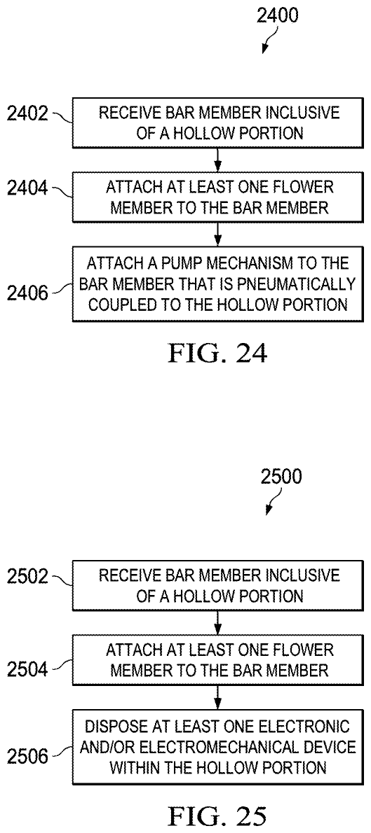

FIG. 24 is a flow diagram of an illustrative process for manufacturing a fascia tissue fitness device;

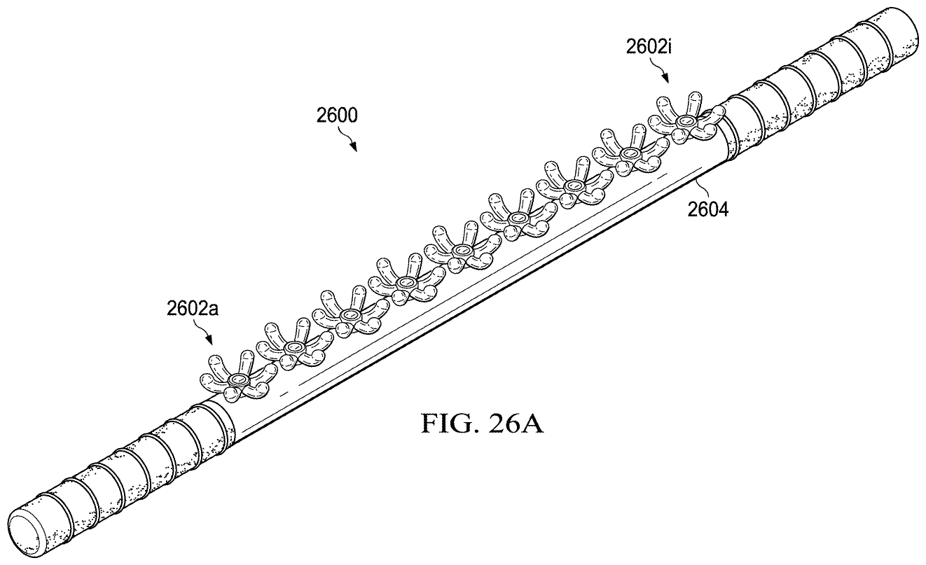

FIG. 25 is a flow diagram of an illustrative process for manufacturing another configuration of a fascia tissue fitness device inclusive of electronic and/or electromechanical components in the fascia tissue fitness device; and

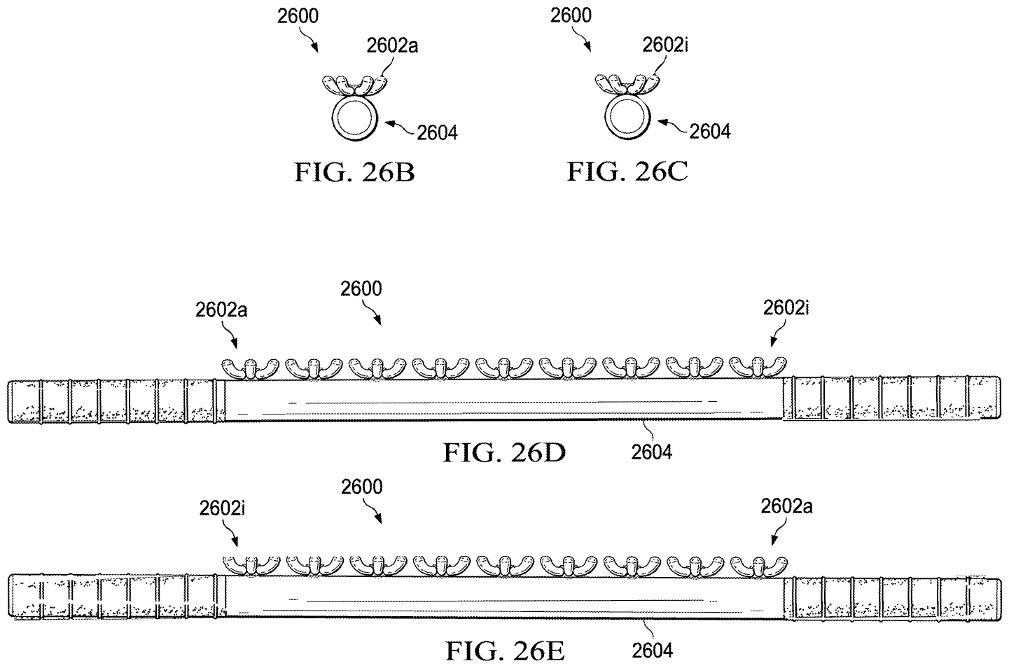

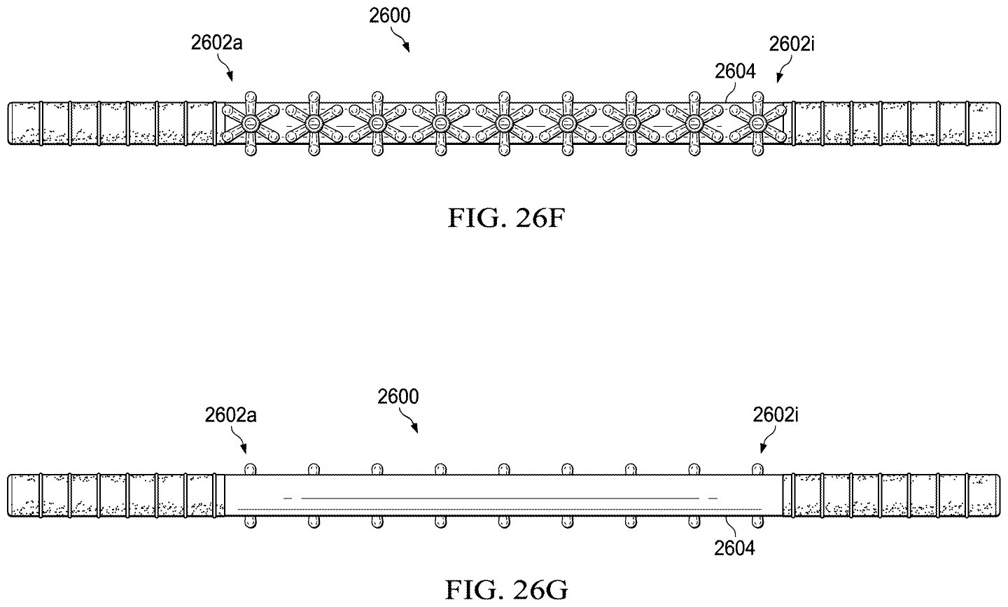

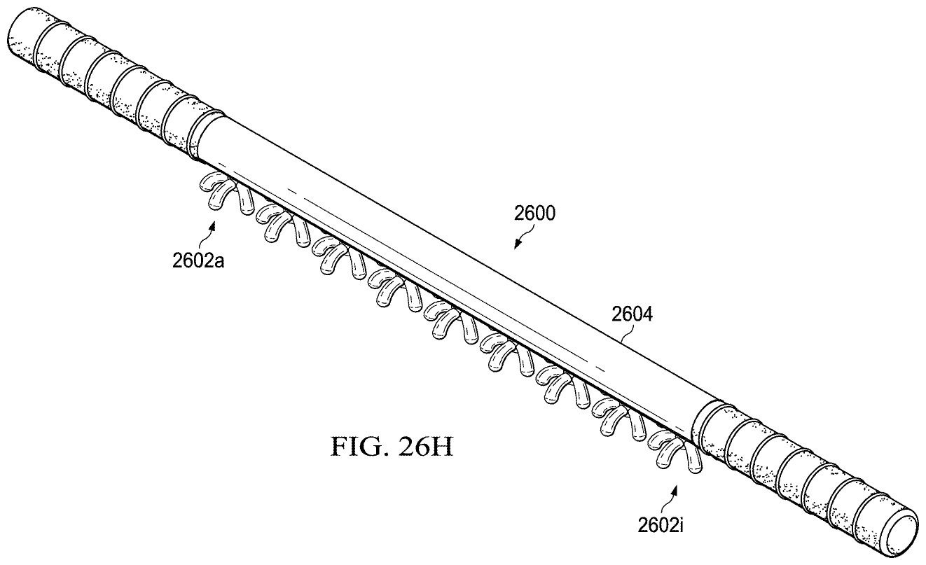

FIGS. 26A-26H are illustrations of an alternative embodiment of a fascia tissue fitness device inclusive of nine “flower” members.

### DETAILED DESCRIPTION OF THE DRAWINGS

With regard to FIG. 1, an illustration of a rear isometric view of an illustrative fascia tissue fitness device 100 is shown. The device 100 may include a bar 102 having handle regions 104a and 104b (collectively 104). The handle regions 104 may have grippers 105a and 105b (collectively 105) formed or applied thereto. The grippers 105 may be formed of rubber or other material to provide gripping in a secure manner to prevent rotation of the bar 102. The handle regions 104 may have the same or different diameter as the bar 102. The length of the bar 102 may be such that the handle regions 104 are positioned about the distance of human shoulders (e.g., 30 inches). As such, there may be multiple lengths of the device 100. In one embodiment, the bar 102 may be extendible formed of one or more elements to be and use a variety of techniques for locking the element(s) to be a fixed length, thereby enabling people with different widths of shoulders to more easily use the device. As shown, however, the bar 102 and handle regions 104 are formed by a molding process that forms a single unit.

The bar 102 should be stiff or rigid, thereby minimizing bending during usages, such as self-usage. Although the bar 102 is shown to have a straight tube profile, it should be understood that alternative configurations of the bar 102 may be utilized. For example, the bar may have a square profile, hexagonal profile, or another geometric or non-geometric profile. Still yet, the bar 102 may be curved, circular, oval, or otherwise to assist in better addressing different modalities and anatomical regions, such as backs, arms, calves, feet, and hands. In an alternative embodiment, rather than using a bar, a board (e.g., circular flat board) having flower members extending from one side of the board may be utilized. To enable a user to use the board, a handgrip and/or hand strap connected to the board may be utilized. Whether a support for the flower members 106 is in a bar, board, or other configuration, an embodiment may provide for the flower members 106 to be in a linear or non-linear alignment with respect to one another.

In one embodiment, and as shown, flower members 106a-106d (collectively 106) are shown to be mounted to the bar 102. The flower members 106 may be formed of acrylic, PVC, hard rubber, or any other material that is stiff and does not cut or scrape skin of a person on which the device 100 is being utilized to help treat or adjust fascia tissue. In the configuration of FIG. 1, there are four flower members. Alternative number of flower members may be utilized. The flower members 106 are shown to be evenly spaced along a plane extending along the bar 102. Alternative spacing of the flower members 106 may be utilized. The flower members 106 are also shown to be substantially identical. Alternative configurations of the flower members 106 may be utilized to provide for treating different size anatomical regions. It should be understood that a different number of flower members 106 may be utilized depending on the dimensions of the flower members 106 and other factors. In one embodiment, the bar 102 may have flower members 106 of different sizes so as to be available to treat different anatomical regions or different sized individuals. As an example, different sized flower members 106 may be positioned on opposite sides, for example of the bar 102 and facing away from one another to allow a single device to be used to treat the different anatomical regions and/or different sized individuals.

The flower members 106 shown are about 1½ inches in diameter. However, the diameter of the flower members 106 may have a fairly wide range (e.g., ½ inch to 4 inches in diameter). Illustrative finger members 108 shown are about ¾ of an inch long and have heads or tips that are about ⅜ of an inch across. The dimensions and configurations (e.g., curves) of the flower members 106, finger members 108, and tips of the finger members 108 may vary depending on the anatomical region on which the device 100 is to be used. The tips of the finger members 108 may have one or more same or different dimensions as the finger members (e.g., the tips may have a larger diameter by being bulbous). The finger members 108 are shown to be curved. Alternative configurations, such as finger members 108 being straight, may be utilized, as well. The flower members 106 are also shown to be a single member. However, flower members 106 may be formed of multiple elements. Still yet, rather than the device 100 using flower members 106 that have a flower-like appearance (i.e., central portion with extending finger members), flower members 106 with non-flower-like appearance may be utilized, as well, that still provides a user with a number of closely spaced pressure-point elements that can be pressed and guided along a person's skin to cause fascia tissue to be released or perform a non-therapeutic function. The finger members 108 may be substantially the same length (e.g., less than 0.1 inch difference in length between finger length) such that the tips of the finger members 108 are substantially co-planer so that a pressure load applied to the skin and fascia tissue is substantially equally applied by each of the finger members 108.

Each of the flower members 106 are shown to have six finger members 108. Alternative numbers of finger members 108 may be utilized. The finger members 108 may be stiff or rigid, thereby having minimum bend or deformation during usage of the device on fascia tissue of a person. Moreover, the finger members 108 may be curved inward, as shown, so as to have a “claw-like” shape. This shape provides for forces to be applied in a more radial direction relative to the bar 102, when being applied to fascia tissue so that higher vertical forces may be applied to the fascia tissue by a user. Although the flower members 106 are shown to extend along one side of the bar 102, additional flower members have the same or different configurations as the flower members 106 may be included to allow for a single device 100 to provide for different size and configuration of flower members to be used on different anatomical regions.

The bar 102 may have openings (not shown) defined by the bar 102 through which a screw or other fastening mechanism may extend through flower members 106 into the bar 102. After fastening the flower members 106 to the bar 102, glue or other fastening material, such as epoxy, may be utilized to secure the flower members 106 to the bar 102. A cover (not shown) above the fastening mechanisms may be utilized to limit the ability for someone to access or remove the fastening mechanisms of the flower members 106. Alternatively, the flower members 106 may be configured to allow for a user to more easily replace the flower members 106 to change size, replace broken flower members, or otherwise. Other attachments that may be flower members or non-flower members (e.g., roller) may also be connected to the bar 102 in alternative embodiments.

FIG. 2 is another illustration of a rear isometric view of the illustrative fascia tissue fitness device 100 of FIG. 1.

FIG. 3 is an illustration of a front isometric view of the illustrative fascia tissue fitness device 100 of FIG. 1.

FIG. 4 is an illustration of a close-up view of a “flower” mounted to the bar of the illustrative fascia tissue fitness device of FIG. 1.

While certain features of the device 100 are configured to be optimal usage on fascia tissue, the features also provide for ornamental appearance. For example, the number of flower members 106, configuration of the bar 102, configuration of the handle regions 104, grippers 105, number of finger members 108 on the flower members 106, shape of the finger members 108, and so forth. As such, the overall and certain ornamental features are included in the device 100 in some embodiments. It should be understood that utilizing the device 100 may be used for increasing overall myo-fascial fitness to loosen fascia tissue that is constrained, improve health and/or beauty purposes (e.g., provide a satisfactory feeling to a user and/or alter the appearance of cellulite and skin smoothness). Moreover, usage of the fascia tissue fitness device may open, loosen, restore, and/or revitalize fascia tissue of men and women, young and old.

With regard to FIG. 5, an illustration of an illustrative device 500 inclusive of a first linear bar member 502a and a second linear bar member 502b (collectively 502) is shown. A hinge 504 may be coupled to both the first and second linear bar members 502 at a first end 506a of the first bar member 502a and a first end 506b of the second bar member 502b. The hinge 504 may be utilized to enable the bar members 502 to be (i) in a collapsed or folded state when not being used, and (ii) in a linear, extended or use state, such as shown in FIG. 1, when being used. Although the hinge 504 may provide for the two linear bar members 502 to be held together, it should be understood that alternative coupling mechanisms may be utilized to maintain the bars together, including bands, lines, bungee cords, chains, or other mechanisms that may directly or indirectly be secured to the bar members 502.

The device 500 further includes handles 508a and 508b at opposite ends from the first ends 506a and 506b of the bar members 502a and 502b, respectively. When the bars 502 are in the folded state, the bars 502 may have adjacent sides 512a and exterior sides 512b. Flower members 510a and 510b may be positioned on the exterior sides 512b of the respective bar member 502a and 502b so that the flower members 510a and 510b do not interfere with the device 500 being positioned in the folded state. In use, the device 500 is be configured in the linear state such that the ends 506a and 506b are in contact with one another. To maintain the device in the linear state, a latch 514 may engage a clasp 516. Alternative mechanisms for maintaining the device 500 in the linear state may be used. Because the flower members 510a and 510b are positioned on the opposite side of the hinge 504, when in use, the device 500 remains extended and the hinge 504 does not rotate due to forces on the handles being applied to the side of the hinge 504.

With regard to FIG. 6, an illustration of an illustrative device 600 is shown. Rather than using a hinge or other mechanism that is attached to a first bar member 602a and second bar member 602b (collectively 602), corresponding retention features may be formed on the bar members 602. The retention features may be in the form of multi-threaded screw features, such as a male screw feature 604a on the first bar member 602a and a female screw feature 604b on the second bar member 602b. The threads of the screw features 604a and 604b (collectively 604) are to be aligned so that when the two bar members 602 are attached, flower members 606a and 606b are aligned along a plane to provide for proper operation of the device 600. Although screw features 604 may be utilized, it should be understood that alternative retention features may be utilized, such as lugs or otherwise that are capable of securing the two bar members 602 together. In an embodiment, a clevis pin, screw, or other anti-rotation member (not shown) may be used to extend through aligned openings (not shown) defined by at least a portion of the two bar members when connected to one another.

With regard to FIG. 7, an illustration of a fascia tissue fitness device 700 is shown to include a bar member 702 inclusive of a first handle 704a and a second handle 704b (collectively 704). In one embodiment, the first handle 704a is fixedly attached or formed on the bar member 702 and the second handle 704b may be configured to be removably attached to the bar member 702. The bar member 702 may include a threaded feature 706a, for example, and the second handle 704b may include a complementary threaded feature 706b that enables the handle to be secured to the bar member 702. The bar member 702 may define at least one hollow region 708 in which a lubricant 710, such as oil, may be positioned. In positioning the lubricant 710, the lubricant 710 may be poured or injected into the hollow region 708 via an opening (not shown) defined by the bar member 702. In one embodiment, a receptacle member (not shown), such as a 1-way valve, may be disposed in the opening to allow the lubricant 710 to be injected into the hollow region 708, but prevent the lubricant 710 to be released. In an alternative embodiment, a cap or plug (not shown) may enable the lubricant 710 to be poured or injected into the hollow region 708, and prevent the lubricant 710 from draining when secured in or above an opening.

As shown, a pump 712 may be used by a user to push the lubricant 710 from the hollow region 708 out of the bar member 702. One or more openings (not shown) defined by the bar member 702 may allow for the lubricant 710 to be output from the bar member 702. In one embodiment, the openings may be positioned at or near one or more flower members 714 positioned on the bar member 702. Rather than the hollow region 708 being configured to have the lubricant 710 be poured or injected, the hollow region 708 may be configured to receive and store a cartridge (not shown) inclusive of the lubricant 710. The pump 712 may be part of the cartridge, part of the bar member 702, or a separate mechanism. If a cartridge is used, the cartridge may be fit onto or pierced by an implement that may be used to receive and transfer the lubricant 710 when the pump 712 is depressed. In an alternative embodiment, rather than the bar member 702 defining a hollow region 708, the handle 704b may define a hollow region configured to receive the lubricant 710 or receive a cartridge 716 inclusive of the lubricant 710. In the event of the handle including the lubricant 710, an opening may be defined by the handle (e.g., on the end opposite from the bar member 702).

As shown, the cartridge 716 is not symmetric and is keyed to ensure that the cartridge 716 is positioned in the hollow region 708 in a correct orientation to enable a pump or other mechanism to engage the cartridge 716. In one embodiment, a tube (not shown) may be connected to a needle, spout, or other mechanism that punctures the cartridge 716 as the user inserts the cartridge into the hollow region 708. It should be understood that a wide variety of mechanisms may be utilized to enable a cartridge containing lubricant to be utilized. It should further be understood that the cartridge 716 is illustrative and that alternative configurations may be utilized to provide for the function of enabling lubricant to be dispensed from the fitness device 700. A pump mechanism (not shown) may be included to force the lubricant from the cartridge 716 via an opening defined by the bar member 702 or handle(s) 704.

With regard to FIG. 8, an illustration of an alternative embodiment of a fascia tissue fitness device 800 is shown to include a bar member 802 that defines an hollow region 804 in which a lubricant 806 may be disposed. As described with regard to FIG. 7, the lubricant 806 may be disposed by pouring or injecting the lubricant 806 into the hollow region 804 if configured as a reservoir. Alternatively, the lubricant 806 may be stored in a cartridge (not shown) that may be inserted into the hollow region 804. As shown, access to the hollow region 804 may be via an opening 808 defined by the bar member 802 adjacent to the hollow region 804 and sealed by a removable cover 810. In one embodiment, openings (not shown) may be defined by the bar member 802 and/or flower members 812, such as through the base 814, fingers 816, and/or tips 818 of the flower members 812 to enable the lubricant 806 to be output via the opening(s).

With regard to FIG. 9, an illustration of an illustrative implement 900 configured to massage or otherwise treat fascia tissue in a localized region, such as a hand, is shown. The implement 900 may have a tapered shape from a base 902 to a tip 904. The profile of the implement 900 may be conical or narrow. Other shapes of the implement 900 may be used. As shown, the height of the implement 900 may be approximately 1 cm and the curve of the tip 904 may be approximately 2 cm. It should be understood that alternative dimensions may be utilized. The implement 900 may be formed of a rigid material, such as hard plastic, metal, wood, or other rigid material that is resistant to bending when applied to tissue of a person. The base 902 may include a connection member 906, such as a threaded screw, that may be used to secure to an end of a handle (not shown) or a bar member (not shown) having a complementary connection member, such as a female connection member.

With regard to FIG. 10, an illustration of an alternative illustrative implement 1000 configured to massage or otherwise treat fascia tissue in a localized region, such as a hand, is shown. The implement 1000 may be used to treat fascia in a different way and in different regions than those ways and regions of the implement 900 of FIG. 9. The implement 1000 may have a tapered shape from a base 1002 to a tip 1004. The profile of the implement 1000 may be conical or narrow. Other shapes of the implement 1000 may be used. As shown, the height of the implement 1000 may be approximately 1 inch and the curve of the tip 1004 may be approximately 1 cm. It should be understood that alternative dimensions may be utilized. The implement 1000 may be formed of a flexible material, such as rubber, silicon, or other flexible material that is bends or flexes when applied to tissue of a user or other person. In an embodiment, the tip 1004 may be soft or flexible and the remainder of the implement 1000 may be rigid. The base 1002 may include a connection member 1006, such as a threaded screw, that may be used to secure to an end of a handle (not shown) or a bar member (not shown) having a complementary connection member, such as a female connection member.

With regard to FIG. 11, an illustration of an illustrative implement 1100 that may operate as a skin stimulator is shown. The implement 1100 may include a base 1102 and fingers 1104 that may be rigid, semi-rigid, or flexible. In one embodiment, the fingers 1104 may be approximately 1 inch. Other lengths, such as between approximately ½ inch and 1½ inches, of the fingers 1104 may be utilized. In one embodiment, the fingers 1104 may be made of a flexible material, such that the fingers 1104 deflect or bend a predetermined amount when applied to the skin of a user. Alternative amounts of flexibility of the fingers 1104 may be available for different types of skin stimulators. The base 1102 may include a connection member 1106, such as a threaded screw, that may be used to secure to an end of a handle (not shown) or a bar member (not shown) having an opposing connection member 1106.

With regard to FIG. 12, an illustration of an illustrative implement 1200 that is configured as a fascia traction device is shown. The implement 1200 may be configured with a pair of fingers 1202a and 1202b (collectively 1202) that are separated by a distance D. The distance D may be approximately 2 inches, in one embodiment. Alternative distances, such as between approximate 1 inch and approximately 4 inches, may be utilized, as well. To provide for traction functionality, the fingers 1202 may have finger tips 1204a and 1204b inclusive of a rubber or other slide resistance material. A base 1206 may include a connection member 1208, such as a threaded screw or otherwise, for securing the implement 1200 to a fascia tissue fitness device.

With regard to FIG. 13, an illustrative fascia tissue fitness device 1300 inclusive of a bar member 1302 and handles 1304a and 1304b is shown. At the end of each of the handles is the implement 1100 (skin stimulator) and implement 900 (rigid fascia tissue fitness device). Each of the handles 1304a and 1304b may include a connection member (not shown) on the end to enable the implements 1100 and 900 to be removably attached thereto. In an alternative embodiment, rather than having handles, the bar member 1302 may have flat or other shaped ends onto which the implements 1100 and 900 may be removably attached.

With regard to FIG. 14, an illustration of an illustrative fascia tissue fitness device 1400 is shown to include a bar member 1402 defining a hollow portion 1404 in which at least one heating element 1406, such as a heating coil, may be disposed, and configured to heat at least one flower member 1408. To power the heating element(s) 1406, a battery 1410, or other power supply (e.g., transformer with a cord that plugs into a wall socket) (not shown) may be utilized. The battery 1410 may be a rechargeable battery or non-rechargeable battery, as understood in the art. As shown the heating element(s) 1406 may be thermally coupled to a base of each of the flower member(s) 1408 that include a thermally conductive material, such as steel, that extends through fingers 1412 of the flower member(s) 1408 to heat tips 1414 of the fingers 1412. In one embodiment, the heating element(s) 1406 may be calibrated to heat the tips 1414 of the fingers 1412 to be approximately 105 degrees Fahrenheit. Alternative temperatures may be utilized, such as between 95 degrees Fahrenheit and 120 degrees Fahrenheit. In an embodiment, an ON/OFF switch 1416 may be disposed on the bar device 1400 (e.g., along the bar member 1402 or end of either handle 1418a and 1418b). In addition to the ON/OFF switch, a temperature control mechanism 1420 may be used to set the temperature either at a specific temperature or at a relative temperature (e.g., “warm,” “hotter,” “hot”) to provide more flexibility to a user in using the device 1400. Although not shown, it should be understood that a reservoir or hollow region in which lubricant may be stored and ejected from the device 1400, as described hereinabove, may be included.

With regard to FIG. 15, an illustration of an illustrative fascia tissue fitness device 1500 is shown. The device 1500 may include a bar member 1502 defining a hollow portion 1504 in which at least one vibration generation mechanism 1506 configured to vibrate one or more flower members 1508 may be positioned. The vibration generation mechanism(s) 1506 may be fixedly attached (e.g., screwed, glued, or otherwise coupled) to the bar member 1502, thereby causing the entire device 1500, including the flower members 1508, to vibrate. In one embodiment, rather than being on the inside of the bar member 1502, the vibration generation mechanism(s) 1506 may extend through or be positioned on the bar member 1502. The flower members 1508 may be fixedly or removably attached to the vibration generation mechanism(s) 1506, but should be connected in such a way that a maximum amount of vibration is transferred from the vibration generation mechanism(s) 1506 to the flower members 1508. A battery 1510 may be utilized for powering the vibration generation mechanism(s) 1506. Alternative power sources may be utilized for powering the vibration generation mechanism(s) 1506, as well. In an alternative embodiment, the device 1500 may have one vibration generation mechanism connected to one or more elements onto which the flower members 1508 are connected. It should be understood that the device 1500 may include one or more flower members 1508.

With regard to FIG. 16, an illustration of an illustrative fascia tissue fitness device 1600 that includes a bar member 1602 that defines a hollow region 1604 is shown. The bar member 1602 may define a slot or track 1606 through which flower members 1608 may connect with a translation member 1610 within the hollow region 1604. An actuator 1612 may be configured to drive the translation member 1610 back and forth within the bar member 1602. As shown flower members 1608 may be connected to the translation member 1610 so that as the translation member 1610 moves axially back and forth, the flower members 1608 also move back and forth. A power source 1614 may be electrically connected to the actuator 1612 to energize the actuator 1612.

The actuator 1612 may be an electromechanical, pneumatic, hydraulic, or other motor or actuator that is configured to cause a translation motion of the translation member 1610 that may range have a distance of approximately one-half inch to approximately three inches or more. Alternative translation distances may also be possible depending on the size of the bar member 1602, actuator 1612, and/or flower members 1608. It should be understood that the device 1600 may alternatively include a single flower member. It should also be understood that alternative members other than a flower member may be attached to the translation member 1610. The translation member 1610 may be directly or indirectly connected to the actuator 1612. A power switch 1616 may be configured to turn ON and OFF the actuator 1612. A speed control selector 1618 may enable a user to alter speed of the actuator 1612 and a distance control selector 1620 may enable a user to alter distance that the translation member 1610 may be driven by the actuator 1612.

In operation, a user may hold handles 1622a and 1622b in a position that allows the flower members 1608 to be moved back and forth against fascia tissue of a user in performing a modality. Depending on the particular fascia tissue being treated, the user may alter speed and travel distance of the flower members 1608. As an example, if the user is treating fascia tissue at the top of a leg, then a maximum speed and distance may be set. If the user is treating an arm or calf, then a lower speed and distance may be set. If the user turns off the actuator 1612, then the user may use the device 1600 as a device with fixed flower members, as previously described.

With regard to FIG. 17, an illustration of an illustrative fascia tissue fitness device 1700 that includes a bar member 1702 that defines a hollow region 1704 is shown. One or more flower members 1706 may be coupled to the bar member 1702 via pressure sensor(s) 1708. The pressure sensor(s) 1708 may be configured to determine pressure or force that a user is placing on his or her body (or another person's body) when using the device 1700. In one embodiment, an electronic circuit 1710, which may include a processing device, may be in communication with the pressure sensor(s) 1708, and may be configured to receive pressure sensor signal(s) 1712 from the pressure sensor(s) 1708 via a communications channel 1714. Responsive to receiving the pressure signal(s) 1712, the electronic circuit 1710 may determine whether the pressure signal(s) 1712 are within a range, such as between approximately 10 lbs/sq-in and approximately 40 lbs/sq-in\hat{ }2, of pressures for appropriate use of the device 1700. Alternative pressure ranges may be utilized. The pressure ranges and levels may also vary based on gender, age, pain tolerance, treatment type, modality, body part, injury, and so forth.

In one embodiment, a pressure sensor setting function may be available via a control mechanism 1716, such as a knob, dial, switch, or otherwise, to enable the user to adjust the pressure range or set the pressure sensor setting function to a particular modality. The pressure range may be different depending on the modality being performed. For example, pressure for a leg may be different than pressure for neck or arm. The electronic circuit 1710 may be configured to sense that the pressure being applied is within the desired pressure range and to generate a desired pressure signal 1718 to cause a device 1720 to dynamically generate a sound (e.g., tone at one or more frequencies, click, Geiger sensor sound, or otherwise), vibration, light (via one or more LED that may include different colors, such as red, yellow, green), pressure on an electronic display, or combination thereof so that the user knows when he or she is applying an appropriate amount of pressure. In one embodiment, if an electronic display or other indicator (e.g., series of LEDs) is utilized, then a maximum pressure may be stored and displayed for the user to view to see a maximum pressure applied during a treatment session. A reset button or other mechanism 1722 may be pressed to clear or reset the maximum pressure.

With regard to FIG. 18, an illustration of an illustrative fascia tissue fitness device 1800 that includes a bar member 1802 and one or more flower members 1804 is shown. In one embodiment, the flower member(s) may be sized as previously described. Alternative sizes of flower member(s) may be utilized. As shown, a handle 1806 may be affixed to or formed on the bar member 1802. On an end 1808 of the bar member 1802 opposite the handle 1806, a curved tip 1810 may be provided. The curved tip 1810 may have a defined curve, such as an approximately 1 cm curve. Alternative diameter curves may be utilized. The curved tip 1810 may be formed as part of the bar member 1802 or may be an attachment or implement that is permanently or removably attached to the bar member 1802. The curved tip 1810 may be utilized to treat fascia tissue that is smaller or positioned in smaller or more isolated regions, such as a user's hand or foot.

With regard to FIG. 19, an illustration of another illustrative fascia tissue fitness device 1900 that includes a bar member 1902 and one or more flower members 1904 is shown. The flower members 1904 may be a standard size, such as previously described, or smaller with the same or similar configuration (e.g., finger shapes, finger tip size, material, etc.). In this configuration, the bar member 1902 is shorter than a bar member with handles, such as shown in FIG. 1, and is meant to be directly gripped by a user. Diameter of the bar member 1902 may be the same or different from that shown in FIG. 1. Length of the bar member 1902 may be approximately 3 inches long. Alternative lengths, such as between approximately 2 inches and approximately 6 inches. Such as device 1900 may be used by a user on his or her shoulders, calves, arms, neck, face, or other areas in which a smaller fascia tissue fitness device can be more effective and manageable than a larger fascia tissue fitness device. One or both ends 1906a and 1906b of the bar member 1902 may be shaped to be functional, as well as being ornamental. As an example, one end 1906a may be shaped with an approximate 2 cm curve, and the other end 1906b may be shaped with an approximate 1 cm curve. Alternative shaped curves may be utilized, as well. In another embodiment, a more ornamental shape, such as a bullet shape, of the bar member 1902 may be utilized. Although the bar member 1902 is shown as a tube, it should be understood that alternative shapes or profiles may be utilized.

With regard to FIG. 20, an illustration of an illustrative fascia tissue fitness device 2000 that is a model of the fascia tissue treating device 1900 of FIG. 19 is shown. The device 2000 includes a bar member 2002 shown to have symmetric ends 2004a and 2004b (collectively 2004). The ends 2004 as shown are not sized to be used for small fascia tissue regions, such as hands or feet, but may have alternative configurations with small diameters (e.g., approximately 1 cm to approximately 3 cm) to be used for treating fascia tissue in smaller or more focused areas. As described with regard to FIG. 19, flower members 2006 may have regular or smaller dimensions and be formed of stiff or rigid materials.

With regard to FIG. 21, an illustration of an illustrative fascia tissue fitness device 2100 that is formed of a bar member 2102 inclusive of a handle 2104 is shown. In this case, the bar member 2102 may have an end 2106 opposite to the handle 2104 that may have a removable implement 2108 or shaped tip 2110 (e.g., about a 2 cm curve) that is configured to provide for specific treatment usage, such as to treat fascia in a hand. As shown, the bar member 2102 may be configured to have one or more different implements 2112 removably attached thereto. The implements 2112 may include a flower member 2112a, “nugget” implement 2112b, “nugget” implement 2112c, skin stimulator 2112d, and/or fascia traction member 2112e, which are described hereinabove.

With regard to FIGS. 22A, 22B and 22C, three illustrations of an illustrative fascia tissue fitness device 2200 are shown. FIG. 22A is a top view of the device 2200, FIG. 22B is a side view of the device 2200, and FIG. 22C is a perspective view of the device 2200. The device 2200 is shown to include a handle member 2202 and a bar member 2204 being connected to one another. In an alternative embodiment, the handle member 2202 and bar member 2204 are formed from a single piece of material. A flower member 2206 may be connected to the bar member 2204, and have the same or similar dimensions and profile as described hereinabove. Moreover, the flower member may be formed of a rigid or stiff material, as previously described. In this embodiment, an end portion 2208 may have an implement 2210 that has a tip 2212 with a curved profile, such as a 2 cm curve. Rather than being an implement 2210, the end portion 2208 may be integral with the bar member 2204, thereby being formed from a single piece of material. However, for manufacturing purposes, the use of a separate implement may be less expensive to produce. Moreover, the implement 2210 may be removably attached so that alternative implements may be attached to the tip 2212. As further shown, the flower member 2206 may be attached to the bar member 2204 via a base 2214 that fixedly or removably attaches the flower member 2206 to the bar member 2204. In one embodiment, a screw or other fastening member (not shown) may be utilized to secure the base 2214 to the bar member 2204. The handle member 2202 is shown to include a series of notches 2216 that may be used to improve a grip of the device 2200 by a user.

With regard to FIGS. 23A, 23B, and 23C, illustrations of an illustrative fascia tissue fitness device 2300 are shown. FIG. 23A is a side view of the device 2300, FIG. 23B is a top view of the device 2300, and FIG. 23C is a side view of the device 2300. The device 2300 is shown to include a bar member 2302 to which a first implement 2304a and a second implement 2304b (collectively 2304) are connected. The implements 2304 may be removably attached to the bar member 2302. The implements 2304 may be tapered and have the same or different profiles as one another. One or more flower members 2306 may be attached to the bar member 2302 via a base member 2308, and be removably attached to the bar member 2302. By being removably attached, the flower member(s) 2306 may be removed and replaced in the event that (i) one or more break or (ii) a different type of flower member or implement is to be connected to the bar member 2302. Length of the bar member 2302 may range from a couple of inches to six inches or more, and the flower members 2306 may be standard size or smaller, as previously described. If smaller, fingers 2310 may have tips 2312 that may be the approximately the same dimensions as standard flower members or may be smaller for use on fascia tissue that may be on smaller anatomical regions.

With regard to FIG. 24, a flow diagram of an illustrative process 2400 for manufacturing a fascia tissue fitness device is shown. The process 2400 may start at step 2402, where a bar member inclusive of a hollow portion may be received. The bar member may be tubular or any other shape, and optionally be configured with handle members on each end of the bar member. At step 2404, at least one flower member may be attached to the bar member. The flower member may have a “claw-like” shape with multiple fingers, such as six.

At step 2406, a pump mechanism may be attached to the bar member, where the pump mechanism may be pneumatically coupled to the hollow portion. In one embodiment, the hollow portion may be configured as a reservoir in which lubricant, such as oil, may be disposed. The pump mechanism may be used to cause the lubricant to be discharged, such as sprayed, from the bar member. In one embodiment, the bar member may define an opening through which the lubricant may be expelled. A spray nozzle may be positioned at the opening and, optionally, tube may extend between the opening hollow portion to enable the lubricant to be transported from the hollow portion to the opening and sprayed via the nozzle. The bar member may further define an opening through which the lubricant may be poured or injected into the hollow portion. A cap or stopper may be used to seal the lubricant in the hollow portion.

In an alternative embodiment, the hollow portion may be configured to receive a cartridge in which the lubricant is contained, and the pump mechanism may engage the cartridge so as to cause the lubricant stored in the cartridge to be released or ejected via an opening (and spray nozzle) defined by the bar member. In one embodiment, the bar member may include handles that may be removably attached to the bar member, and the hollow portion may be within the handles such that the lubricant or a cartridge containing the lubricant may be contained within one or both of the handles. In one embodiment, if a cartridge is used, the cartridge may be “keyed” so as to allow the user to insert the cartridge in a proper configuration to align the cartridge with a tube, opening, or other member used to expel the lubricant from the device, and to enable the pump mechanism to cause the lubricant to be discharged from the cartridge.

With regard to FIG. 25, a flow diagram of an illustrative process 2500 for manufacturing a fascia tissue fitness device is shown. The process 2500 may start at step 2502, where a bar member inclusive of a hollow portion may be received. The bar member may be tubular or any other shape, and optionally be configured with handle members on each end of the bar member. At step 2504, at least one flower member may be attached to the bar member. The flower member may have a “claw-like” shape with multiple fingers, such as six.

At step 2506, at least one electronic and/or electromechanical device may be disposed within the hollow portion. As an example, the electronic device may include a battery, transformer, processing unit, analog circuitry, digital circuitry, sensor(s) (e.g., pressure sensor, motion sensor, temperature sensor), heating element, combination thereof, and/or any other electronic device configured to support the functionality described herein. The electromechanical device may include an actuator, such as an electromechanical actuator, motor, translation mechanism, rotational mechanism, electromagnetic device, and so on. The electronic device(s) may be configured to interact with the electromechanical device(s) to support functions, as previously described.

With regard to FIGS. 26A-26H, illustrations of an alternative embodiment of a fascia tissue fitness device 2600 inclusive of nine “flower” members 2602a-2602i (collectively 2602) are shown. FIG. 26A is a bottom perspective view of the fascia tissue fitness device 2600. FIG. 26B is a left-end view of the fascia tissue fitness device 2600. FIG. 26C is a right-end view of the fascia tissue fitness device. FIG. 26D is a left-side view of the fascia tissue fitness device 2600. FIG. 26E is a right-side view of the fascia tissue fitness device 2600. FIG. 26F is a bottom view of the fascia tissue fitness device 2600. FIG. 26G is a top view of the fascia tissue fitness device 2600. FIG. 2611 is a top perspective view of the fascia tissue fitness device 2600. In an embodiment, the “flower” members 2602 are approximately half the dimensions as the “flower” members 106 of FIG. 1 on the approximately same sized bar 2604 as the bar 102 of FIG. 1. Such sized “flower” members 2602 may provide for a higher resolution of treatment of fascia tissue. Moreover, the smaller “flower” members 2602 may allow for treatment on smaller anatomical regions, such as arms and necks, along with smaller individuals, such as children.

A variety of different configurations of tissue fitness devices have been described hereinabove. It should be understood that the various configurations may be combined in ways that provide for two or more of the features of the different devices described herein to be available to a user. As an example, a tissue fitness device may combine multiple features so as to be configured with one or more hollow portions in which a reservoir or cartridge for lubricant may be stored along with heating elements to heat flower members may be positioned. In another example, a tissue fitness device may be configured with multiple features, such as an actuator and a translation mechanism that are configured to automatically translate one or more flower members along with a reservoir and pump mechanism for storing and spraying a lubricant via an opening defined by a bar or handle member of the tissue fitness device.

The previous description is of a preferred embodiment for implementing the invention, and the scope of the invention should not necessarily be limited by this description. The scope of the present invention is instead defined by the following claims.

What is claimed:

1. A fascia tissue fitness device, comprising:
a structural member;
at least one fascia tissue treatment element configured to be moved relative to said structural member;
a translation member supported by said structural member onto which said at least one treatment element is affixed; and
an actuator coupled to said translation member, and configured to cause said translation member to repeatedly move back and forth relative to said structural member such that said at least one fascia tissue treatment element moves back and forth to treat fascia tissue of a user.

2. The fascia tissue fitness device according to claim 1, wherein the translation member is configured to cause said translation member to repeatedly move linearly back and forth.

3. The fascia tissue fitness device according to claim 1, wherein the translation member is disposed within said structural member.

4. The fascia tissue fitness device according to claim 1, wherein said actuator is an electromechanical, pneumatic, or hydraulic motor configured to cause translation of said translation member.

5. The fascia tissue fitness device according to claim 1, wherein said actuator is configured to cause translation of said translation member in a range between approximately one-half inch and approximately three inches.

6. The fascia tissue fitness device according to claim 1, wherein said actuator is electrically powered and configured to be electrically coupled to a power source.

7. The fascia tissue fitness device according to claim 6, further comprising a power switch to control power provided to said actuator.

8. The fascia tissue fitness device according to claim 1, further comprising a speed control selector configured to alter speed of said actuator.

9. The fascia tissue fitness device according to claim 1, further comprising a distance control selector configured to alter a distance that said translation member is driving by said actuator.

10. The fascia tissue fitness device according to claim 1, further comprising a sensor configured to sense force being applied by said at least one fascia tissue treatment element on a user's body.

11. The fascia tissue fitness device according to claim 10, further comprising a control mechanism configured to adjust a pressure range of the device.

12. The fascia tissue fitness device according to claim 1, wherein said at least one fascia tissue treatment element includes a plurality of finger members that are rigid and extend outward from said structural member.

13. The fascia tissue fitness device according to claim 12, wherein said at least one fascia tissue treatment element further includes a base extending from the structural member and having a top surface and a side surface extending between the top surface and the structural member, each of the finger members including a cylindrical shaft having a base portion and a tip portion, the base portion of the finger members extending from the side surface such that the base portion does not directly extend from the top surface, the base portion arcing toward the tip portion, the arc including a concave contour that extends from the side surface of the base to the tip portion of the finger members, and a convex contour that is opposite of the concave contour, and includes a curvature greater than a curvature of the concave contour, the convex contour extending from the side surface of the base to the tip portion of the finger members, thereby forming finger members that curve away from the base and the singular, linear, and uniformly tubular bar.

14. A fascia tissue fitness device, comprising:
a structural member;
at least one fascia tissue treatment element supported by said structural member;
a sensor configured to sense pressure being applied to a user by said at least one fascia tissue treatment element, and to generate a sensor signal representative of the pressure being sensed; and
an electronic circuit configured to receive the sensor signal and generate an output signal based on the pressure being sensed.

15. The fascia tissue fitness device according to claim 14, wherein the pressure being applied by said at least one fascia tissue treatment is being applied by the user.

16. The fascia tissue fitness device according to claim 15, wherein the pressure being applied by said at least one fascia tissue treatment is being applied on the user.

17. The fascia tissue fitness device according to claim 14, wherein the electronic circuit is further configured to determine whether the applied pressure is within a predetermined range.

18. The fascia tissue fitness device according to claim 14, further comprising a control mechanism configured to adjust a pressure range of the device.

19. The fascia tissue fitness device according to claim 18, wherein the control mechanism is a knob, a dial, or a switch.

20. The fascia tissue fitness device according to claim 14, wherein the output signal causes the device to generate at least one of a sound, a vibration, a light, or a value on an electronic display.

21. The fascia tissue fitness device according to claim 14, further comprising:
a translation member supported by said structural member onto which said at least one treatment element is affixed; and
an actuator coupled to said translation member, and configured to cause said translation member to repeatedly move back and forth relative to said structural member such that said at least one fascia tissue treatment element moves back and forth to treat fascia tissue of a user.

22. The fascia tissue fitness device according to claim 21, wherein said translation member is configured to be moved linearly back and forth relative to said structural member.

23. The fascia tissue fitness device according to claim 21, wherein said translation member is configured to be moved linearly back and forth within said structural member.

24. The fascia tissue fitness device according to claim 14, wherein said at least one fascia tissue treatment element includes a plurality of finger members that are rigid and extend outward from said structural member.
